(19) United States
(12) Patent Application Publication
(10) Pub. No.: US 2004/0244296 A1
(43) Pub. Date: Dec. 9, 2004

(54) Locking device for a hung sash window

(75) Inventors: Alfred Dinkelborg, Salchendorf (DE); Jurgen Sassmannshausen, Hilchenbach (DE)

Correspondence Address: HENRY M FEIEREISEN, LLC, 350 FIFTH AVENUE, SUITE 4714, NEW YORK, NY, 10118, US

(73) Assignee: SIEGENIA-AUBI KG, Siegen (DE)

(21) Appl. No.: 10/856,308

(22) Filed: May 28, 2004

Related U.S. Application Data
(63) Continuation of application No. PCT/EP03/06219, filed on Jun. 13, 2003.

(30) Foreign Application Priority Data
Jul. 17, 2002 (DE) 202 10 832.5

(51) Int. Cl. E05F 3/00

(52) U.S. Cl. 49/449

(57) ABSTRACT

A locking device for a sash of a hung sash window includes a movable mushroom-shaped locking pin disposed on the first movable sash and a lock engaging element disposed on the window jamb or the rail of the second sash. The locking pin can be actuated by a driving rod located in a driving rod mounting. The lock engaging element is in the form of a laterally open profiled part which has an inverted Ω-(omega) shaped cross-section that is complementary to the shape of the locking element.

### CROSS-REFERENCES TO RELATED APPLICATIONS

This application is a continuation of prior filed copending PCT International application no. PCT/EP2003/006219, filed Jun. 13, 2003, which designated the United States and on which priority is claimed under 35 U.S.C. §120, the disclosure of which is hereby incorporated by reference.

This application claims the priority of German Patent Application, Ser. No. 202 10 832.5, filed Jul. 17, 2002, pursuant to 35 U.S.C. 119(a)-(d), the disclosure of which is incorporated herein by reference.

### BACKGROUND OF THE INVENTION

The present invention relates, in general, to a sash window, and more particularly to a locking device for a hung sash window sash.

U.S. Pat. Nos. 5,244,238 and 5,791,700 describe locking devices which include a driving rod actuator arranged in an upper horizontal rail of a sash. The sash engages, on one hand, with locks disposed in the lateral guides and attached to the freestanding frame, and, or the other hand, with pivotable locking elements that cooperate in the closing position of the sash with lock engaging elements located on the driving rods. The lock engaging elements are here located in a lower horizontal rail of an upper sash or a freestanding jamb of the frame. This results in three possible switch positions: in a first switch position, the sash can be secured relative to the frame and optionally to a second sash. In a second switch position, the pivotable locking elements that can be pivoted via the driving rod are moved out of the lock engaging elements, so that the sash can be moved vertically. In a third switch position, the locking elements that engage laterally with the guides are moved out of these guides, and the sash can be pivoted about a lower horizontal axis, while still being supported in the guides at the bottom. In U.S. Pat. No. 5,244,238, the locking elements engaging in the lateral guides are connected with the driving rod via a return stroke, so that the locking element is moved only after this return stroke is exceeded. The locking elements are spring-biased in the engagement direction to ensure that the locking elements engage. U.S. Pat. No. 5,791,700 provides a rigid connection between the locking element and the driving rod, whereby the stroke and sash dimensions relative to the frame are selected so that the locking element in the second switch position remains at least partially engaged with the guides.

Disadvantageously, the entire locking device is relatively complicated. The pivotable locking elements need a special support in the sash or on the driving rod actuator so as to be able to perform the required pivoting action. The known devices also require tight manufacturing tolerances of the sash and the frame.

It would therefore be desirable to provide a locking device which has a simple construction, provides protection against intruders, and can be manufactured cost-effectively.

### SUMMARY OF THE INVENTION

According to an aspect of the invention, a locking device for a hung sash window is disclosed wherein the sash window includes a fixed frame having a jamb and a first sash having an upper horizontal rail and being slidably disposed for vertical movement in relation to a fixed frame, and a second sash having a rail. At least the first sash is slidably disposed for vertical movement in relation to the fixed frame. When the first sash is closed, the upper horizontal rail is located next to the jamb and/or parallel to the rail of the second sash. A movable locking element has the shape of a mushroom-shaped pin and is disposed on the upper horizontal rail with an orientation perpendicular to a major plane of the first sash. A lock engaging element is disposed on the jamb or rail and shaped as a laterally open profiled part. The lock engaging element has a cross-section in the form of an inverted Ω-(omega) shape and includes a locking slot in the form of an undercut formed by opposing ribs. The locking device further includes a driving rod movably held in a driving rod mounting for actuating the movable locking element. The driving rod mounting is secured in a recess facing the jamb or rail. The locking slot of the lock engaging element and a throat section of the mushroom-shaped pin are matched to each other so that a widened head of the mushroom-shaped pin engages behind the opposing ribs.

The proposed solution has the effect that the locking device can be attached to the sash so as to essentially be obscured from view, since it is attached to the backside, i.e., invisible to the user. Installation of the locking device is very simple, since only a groove has to be provided for receiving the driving rod actuator. In addition, the manner in which the locking device locks ensures a very secure connection, so that manipulation, for example by an intruder, is at least made more difficult.

According to one advantageous embodiment, the jamb or rail may include a recess adapted to receive the lock engaging element, wherein the lock engaging element or the recess may include on at least one side an opening that is oriented in the vertical movement direction of the first sash. The locking slot of the lock engaging element may be inclined in a displacement direction of the pin, and the locking slot may be sloped downwardly in an insertion direction of the pin. The locking slot may extend essentially parallel to the jamb or rail and may be include beveled sections to aid insertion or the locking pin. The locking device may further include a driving rod actuator having a toothed drive wheel and a handle for driving the toothed drive wheel, with the tooth pattern of the toothed drive wheel engaging in recesses of the driving rod.

The locking device may advantageously also include a driving rod actuator having a toothed drive wheel and a handle for driving the toothed drive wheel. The tooth pattern of the toothed drive wheel can engage in recesses of the driving rod. The driving rod actuator can have at least one stationarily supported reversing pinion with an axle and engaging with a toothed section of the driving rod, and a second driving rod located opposite the driving rod in diametrical opposition to the axle of the reversing pinion.

In another advantageous embodiment, at least the first sash may include sash corners and the driving rod actuator may extend to the sash corners. A locking element can be associated with an end of the upper horizontal rail facing the sash corners, whereby the locking element can engage in at least one switch position of the driving rod actuator with a lateral guide disposed on the fixed frame of the sash window. The driving rod actuator can have a total switch stroke of approximately 90° and a partial stroke of approximately 45°, whereby the locking element can be carried along over the partial stroke of the driving rod actuator.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a plan view from inside of a window with an upper sash and a lower sash and having incorporated the subject matter of the present invention;

FIG. 2 is a cross-sectional view of the window, taken along the line II-II in FIG. 1;

FIG. 3 is a detailed view, on an enlarged scale, of a lock according to the present invention between the upper sash and the lower sash;

FIG. 4 is a cross sectional view of a lock engaging element of the lock;

FIG. 5 is sectional view of a driving rod mounting with a driving rod actuator and a driving rod extension element;

FIG. 6 is a detailed perspective view, on an enlarged scale, of an end portion of a driving rod component with a guard rail; and

FIG. 7 is a detailed perspective view, on an enlarged scale, of the end portion of a driving rod component without guard rail.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

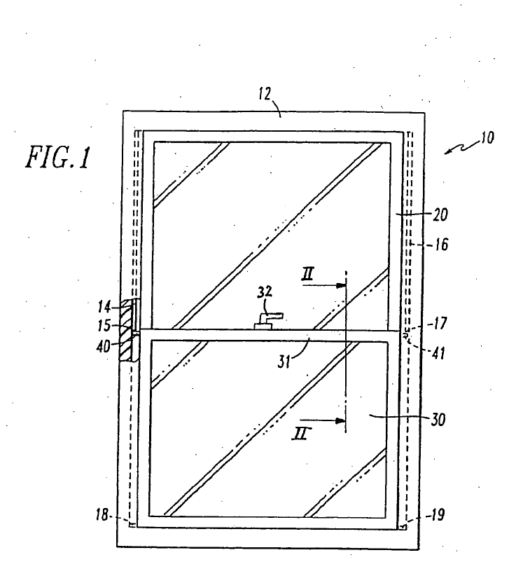

Turning now to the drawing, and in particular to FIG. 1, there is shown plan view from inside of a hung sash window 10 made of a fixed frame 12, an upper sash 20 and a lower sash 30. The frame 12 and the sashes 20, 30 can be made of different materials, for example, of extruded aluminum profile, plastic or wood or of a mixture of these materials. The sashes 20, 30 are provided with transparent panes made of glass or plastic. In addition, the frame 12 has vertical guides 14 and 16 in which the lower sash 30 is vertically guided. The upper sash 20 is also movably guided in additional guides (not shown). Inserts 15 and 17 are secured in the upper section of the guides 14, 16. Each insert 15, 17 is provided with a retention plate under which the movable rod ends 40 and 41 can be locked after the lower sash 30 has been moved completely downward. A handle 32 is provided on the lower sash 30 for operating the locking device of the window 10, as will be described below. The lower sash has support pins 18, 19. Conventional balance elements that are movably guided in the channels 14, 16 can be associated with the support pins 18, 19. The support pins 18, 19 thereby remain engaged and hold the sash 30 on the frame 12 when the locking device is moved to the open position and the lower sash is pivoted inwardly, for example for cleaning purposes.

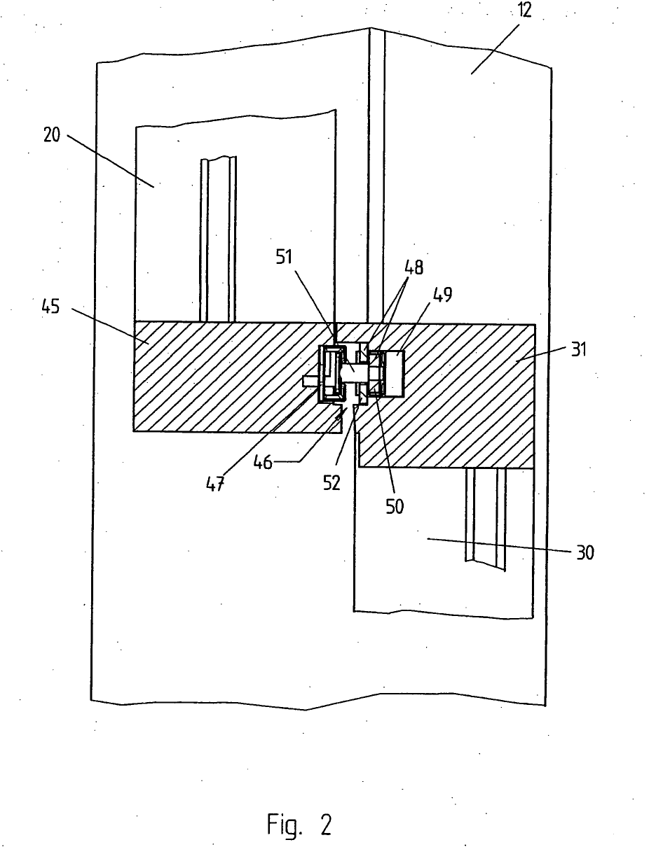

As seen in FIG. 2, in the closed position of the window 10, the upper horizontal rail 31 of the sash 30 is located next to the lower horizontal rail 45 of the sash 20. A locking device 46 for securing the sash 30 on the frame 12 or the sash 20 is secured on the opposing sides of the rails 31 and 35, respectively. A lock engaging element 47 is provided in the rail 45, whereas a driving rod mounting 48 with a stepped groove 49 is provided on the rail 31.

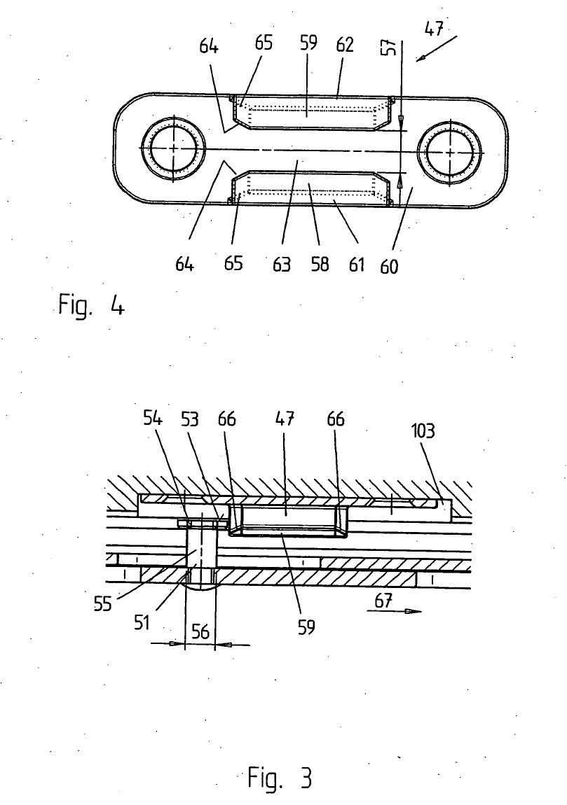

As seen in FIG. 2, a mushroom-shaped pin 51 which extends through a slot in a guard rail 52 that covers the groove 49 is attached on the driving rod 50 and cooperates with the lock engaging element 47. The pin 51 has an end 53 with a widened head 54, as seen more clearly in FIG. 3, and a shaft or section 55 with a diameter that is smaller than the diameter of the head 54. This is commensurate with the distance 57 between the ribs 58, 59. The ribs 58, 59 of the lock engaging element 47 form an undercut, so that the lock engaging element 47 is essentially a profile piece with an inverted Ω-(omega) shaped profile. The U-shaped ribs 61, 62 that project from the baseplate 60 are also separated from each other so as to allow insertion of the widened head 54 of the pin 51. In the closed position depicted in FIG. 2, the lock engaging element 47 grips around the pin 51 in the region of the tapered section 55 and prevents it from moving out of the locking device in an axial direction of the pin 51.

Moreover, the lock engaging element 47 is provided with insertion bevels 64, 65 in the region of the lateral opening of the locking slot 63 along the ribs 58, 59 as well as along the ribs 61 and 62. In this way, when the sash 30 is locked via the driving rod mounting 48, the sash 30 moves towards the lower horizontal frame bar, thereby effecting seals arranged between the sash 30 and the frame 12. In addition, the lock engaging element 47 is also provided with insertion bevels 66 along the ribs 58, 59, which operate perpendicular to the baseplate 60 and in the axial direction of the pin 51. In this way, the sash rail 31 is pulled toward the sash rail 45 when the pin 51 moves in the direction 67. In this way, the existing seals of the sashes 20, 30 can be pressed against the respective other rail of the adjacent sash 30, 20. The engagement of the widened head 54 with the undercut formed by the ribs 58, 59 also prevents a relative motion perpendicular to the opposing faces of the sashes 20, 30, i.e., in the axial direction of the pin 51, for example during an attempted burglary.

In an embodiment where the lock engaging element 47 has a different shape form that depicted in FIGS. 3 and 4, the locking slot 63 of the lock engaging element 47 can also be sloped in the displacement direction of the pin 51, with the locking slot 63 sloping downwardly in the insertion direction of the pin 51.

The inclination bevels 64, 65, 66 extend over a large portion of the length of the lock engaging element 47 and are therefore flatter. As a result, the lock engaging element 47 may no longer be formed symmetrically, as shown for example in FIG. 4.

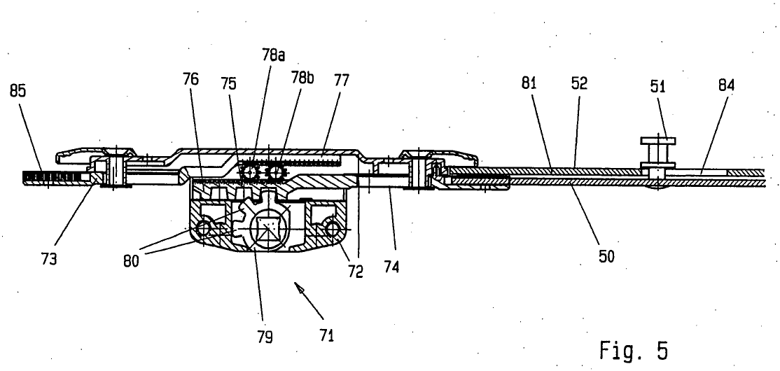

FIG. 5 shows the driving rod actuator 71 for the driving rod mounting 48, with two driving rods 73 and 74 being guided in mutually opposing directions in the housing 72. The end of the driving rod 73 located in the housing 72 has on its longitudinal side a toothed section 75 with a relatively fine tooth pattern, whereas the opposite longitudinal side has a second toothed section 76 with a relatively coarse tooth pattern. The end of the driving rod 74 that projects into the housing 72 also has a toothed section 77 with a fine tooth pattern. The toothed sections 75 and 76 are disposed on the driving rod 73 on the same longitudinal section.

Two mating pinions 78a and 78b engage via corresponding diametrically opposing peripheral sections with the opposing toothed sections 75 and 77 of the two driving rods 73 and 74. The pinions 78a and 78b have closely spaced independently rotatable parallel axles that are supported in the housing 72. Advantageously, the distance between the axles associated with the two pinions 78a and 78b is selected so that they engage with the toothed sections 75 and 77 with an offset of half a tooth spacing. This results in optimal engagement and force transmission characteristics between the pinions 78a and 78b and the toothed sections 75 and 77.

A toothed drive wheel 79 which is also rotatably supported in the housing 72 is in continuous engagement with the toothed section 76 of the driving rod 73. The toothed drive wheel 79 has a geometrical radius that is greater by an integer multiple, for example three times or four times, than the geometrical radius of the pinions 78a and 78b.

As is further shown in FIG. 5, the relatively coarse tooth pattern 80 of the toothed drive wheel 79 is provided with three teeth and extends over an angular range of 90°. Accordingly, the driving rod 73 can be moved across its entire displacement range with the toothed section 76 that has only three tooth spaces by rotating the toothed drive wheel 79 by 90°, for example by using a handle 32 with a square key that engages with a square hole located in the drive wheel 79. The driving rod 74 moves simultaneously over the same distance as driving rod 73, however in the opposite direction.

FIG. 5 also shows a driving rod component 81 located adjacent to and couplable with the driving rod actuator 71. The driving rod component 81 includes a guard rail 82 and a driving rod 50. The driving rod actuator 71, in conjunction with an additional driving rod component (not shown) constructed like the driving rod component 81, forms the driving rod mounting 48. The pin 51 is attached to the driving rod of the driving rod component 81 and extends through a slot 84 of the guard rail 82. The driving rod component 81 is coupled with the driving rod actuator 71 via a fine tooth pattern disposed on the outside of the driving rod 50, which can engage with a fine tooth pattern 85 of the driving rod actuator 71. As the fine tooth pattern on the driving rod 50 extends over a partial length of the driving rod component 81, the driving rod component 81 can be adapted to the dimensions of the sash 30 by shortening the guard rail 82 and the driving rod 50.

Although FIG. 3 shows a single driving rod component 81 located on only one end of the driving rod actuator 71, FIG. 1 shows a window with driving rod mounting components 81 coupled to the window on both sides of the gear 71.

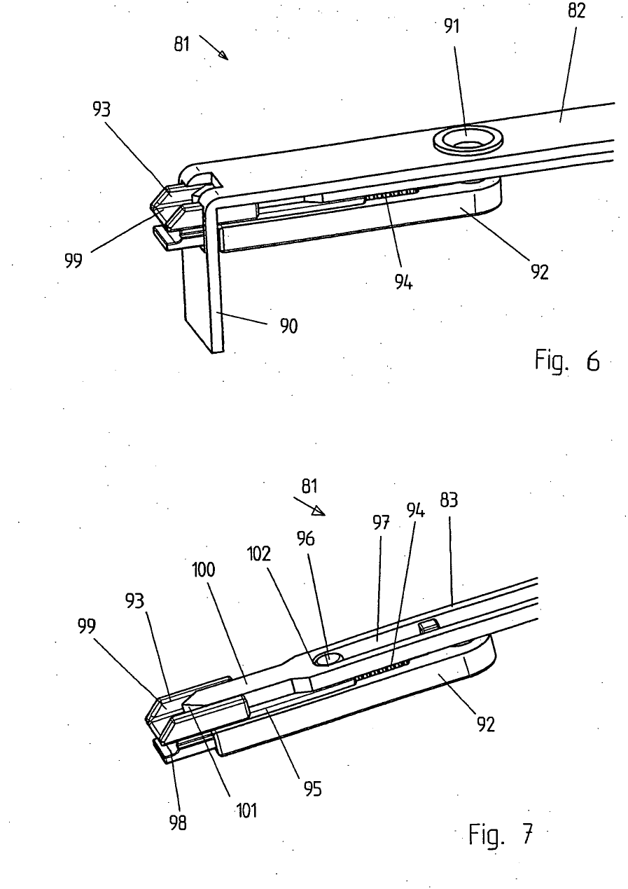

FIGS. 6 and 7 show the end section of the driving rod component 81 with a guard rail (FIG. 6) and without a guard rail (FIG. 7). As seen in FIG. 6, one end of the guard rail 82 is provided with an angle piece 90 that is adapted to contact the groove surface of the sash corner of sash 30. The driving rod component 81 can thereby be easily aligned on the sash 30. The driving rod 50 runs below the guard rail 52. The guard rail 52 is secured via fastening screws extending through bores 91 on the sash 30, with a guide piece 92 supporting the guard rail 52. The guide piece 92 not only supports the guard rail 52, but also guides the locking bar 93 which projects over the outer face of the angle piece 90. The locking bar 93 is spring-biased towards the angle piece 90 by a spring 94 which is supported on the guide piece 92. The guide piece 92 forms a guide with an approximately U-shaped cross-section for the locking bar 93, so that the locking bar 93 is guided along the guard rail 52 with little friction and with being subject to jamming. The locking bar 93 is provided with an extension piece 95 which, on one hand, can extend the guide faces of the locking bar 93 and, on the other hand, allow engagement between a pin 96 provided on the extension piece 95 and a slot 97 of the driving rod 50.

The end of the locking bar 93 also has an essentially U-shaped profile with a groove 98. The top face of the locking bar 93 associated with the guard rail 52 is provided with a U-shaped guide 99 adapted to engage with a tapered section 100 of the driving rod 50.

The driving rod mounting 48 operates as follows: In a first switch position—the closed position shown in FIG. 1—the locking bar 93 is biased by the spring 94 in the position shown in FIG. 6 and holds the sash 30 oriented parallel to sash 20. At the same time, the driving rod 50 is moved to its end position where the tip 101 depicted in FIG. 7 is inserted in a recess of the guide 14, 16. This prevents the sash 30 from moving in the vertical direction. In this switch position, the pin 51 also engages with the lock engaging element 47, so that the sash 30 is pressed against the sash 20 and the frame 12.

When the handle 32 is rotated, for example by 45°, the tip 101 of the driving rod 50 is initially moved out of the recesses (not shown) of the guides 14, 16, so that the sash 30 is held by the locking bar 93 in the guides 14, 16 and can be moved in the vertical direction.

With a further rotation of the handle 32, for example by additional 45°, the pin 96 hits the end 102 of the slot 97 and returns the locking bar with the remaining partial stroke against the return motion of the spring 94. The upper end of the rail 31 of the sash 30 is then released, so that the lower end of the sash 30 can be rotated about the support pins 18, 19, for example for cleaning purposes.

Accordingly, all essential functions of the window 10 can be realized by using the handle 32, while simultaneously preventing manipulation, for example by an intruder.

Installation of the driving rod mounting 48 of the sash 30 is significantly simplified by arranging the driving rod actuator 71 intermediate between the driving rod components 81. The length of the driving rod components 81 can be exactly matched to the dimensions of the sash 30 due to the afore-described toothed section that extends partially along the driving rod 50. A large number of window sizes can be readily assembled using the same components, requiring only a small number of driving rod component 81 and a single driving rod actuator 71. This makes it possible to work with a small inventory and facilitates manufacture of the driving rod components 81.

It should finally be noted that the lock engaging element 47 is preferably attached in a recess 103 of the sash 20, as shown in FIG. 3, and that an opening oriented in the movement direction of the sash 30 is provided on at least one side of the recess 103 either on the lock engaging element 47 or on the recess 103. This allows the pin 51 to move past the corresponding rail 45 of the sash 20 when the sash 20 or 30 is moved.

Alternatively, the driving rods 50, 73 and/or 74 can be constructed identically, i.e., as one piece. The length of the driving rod actuator 71 should then be adapted to the sash dimension.

In an embodiment that is different from the embodiments depicted in FIGS. 6 and 7, the locking bar 93 can also be rigidly attached to the driving rod 50. Unlocking is then accomplished in two stages, whereby in the first stage the locking the bar 93 is only partially moved out of the guide 14, 16 and remains sufficiently engaged so as to still be able to securely guide the sash 30.

In a second stage, the locking bar 93 is completely moved out of the guide 14, 16, so that the sash 30 can be pivoted about the lower pins 19. The stages correspond to two partial strokes of the driving rod 50 and hence to two partial pivoting movements, for example a 45° and 90° rotation of the operating handle 32.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A locking device for a hung sash window with a first sash having an upper horizontal rail, said first sash being slidably disposed for vertical movement in relation to a fixed frame, a second sash, and a locking mechanism for securing the first sash to the second sash, when the first sash is closed and the upper horizontal rail extends next to a jamb of the fixed frame or in parallel relationship next to a rail of the second sash, said locking device comprising:
a movable locking element formed as a mushroom-shaped pin and disposed on the upper horizontal rail with an orientation perpendicular to a major plane of the first sash,
a lock engaging element disposed on the jamb or rail and formed as a laterally open profiled part which has a cross-section in the form of an inverted Ω-(omega) shape and includes a locking slot in the form of an undercut formed by opposing ribs; and
a driving rod movable in a driving rod mounting for actuating the movable locking element, said driving rod mounting secured in a recess facing the jamb or rail,
wherein the locking slot of the lock engaging element and a throat section of the mushroom-shaped pin are matched to each other so that a widened head of the mushroom-shaped pin engages behind the opposing ribs.

2. The locking device of claim 1, wherein the jamb or the rail includes a recess adapted to receive the lock engaging element, and wherein the lock engaging element or the recess includes on at least one side an opening that is oriented in the vertical movement direction of the first sash.

3. The locking device of claim 1, wherein the locking slot of the lock engaging element is inclined in a displacement direction of the pin and the locking slot is sloped downwardly in an insertion direction of the pin.

4. The locking device of claim 1, wherein the locking slot is provided with insertion bevels and extends essentially parallel to the jamb or rail.

5. The locking device of claim 1, and further comprising a driving rod actuator having a toothed drive wheel and a handle for driving the toothed drive wheel, with the tooth pattern of the toothed drive wheel engaging in recesses of the driving rod, at least one stationarily supported reversing pinion having an axle and engaging with a toothed section of the driving rod, and a second driving rod located opposite the driving rod in diametrical opposition to the axle of the reversing pinion.

6. The locking device of claim 5, wherein at least the first sash includes sash corners and the driving rod actuator extends to the sash corners, wherein a locking element is associated with an end of the upper horizontal rail facing the sash corners, with the locking element engaging in at least one switch position of the driving rod actuator with a lateral guide disposed on the fixed frame, said locking element being carried along over a partial stroke of the driving rod actuator.

7. The locking device of claim 6, wherein the driving rod actuator has a switch stroke of approximately 90° and wherein the partial stroke is approximately 45°.
